(19) United States
(12) Patent Application Publication
(10) Pub. No.: US 2024/0233041 A1
(43) Pub. Date: Jul. 11, 2024

(54) CRIMINAL SLANG VARIATION TRACKING METHOD, APPARATUS AND COMPUTER PROGRAM PERFORMING THE SAME

(71) Applicants: KOREA INTERNET & SECURITY AGENCY, Naju-si (KR); NSHC. INC, Seoul (KR)

(72) Inventors: Keun Woo BAE, Naju-si (KR); Yong Hee SHIN, Naju-si (KR); Dae Il JANG, Naju-si (KR); Seung Goo JI, Naju-si (KR); Soo Ho HAN, Seoul (KR); Sang Tae WOO, Seoul (KR)

(21) Appl. No.: 18/000,796

(22) PCT Filed: Sep. 16, 2022
(86) PCT No.: PCT/KR2022/013894

§ 371 Date: Dec. 5, 2022

(30) Foreign Application Priority Data
Dec. 14, 2021 (KR) 10-2021-0178733

(51) Int. Cl. G06Q 50/00

(52) U.S. Cl. CPC G06Q 50/01

(57) ABSTRACT

According to an exemplary embodiment of the present disclosure, a criminal slang variation tracking method and an apparatus and a computer performing the same acquire criminal slang correlation information for every social network service (SNS) channel and acquire criminal slang exposure information to all a plurality of social network service (SNS) channels to analyze correlation between criminal slangs or exposure of the criminal slang.

### TECHNICAL FIELD

The present invention relates to a criminal slang variation tracking method, an apparatus and a computer program performing the same, and more particularly, to a method, an apparatus, and a computer program of tracking a variation of a criminal slang.

This study relates to “a cybercrime activity information tracking technology such as a misused virtual asset transaction (No. 1711117111) conducted by the Korea Internet & Security Agency with the support of the Information and Communication Planning and Evaluation Institute with the funding of the Ministry of Science and ICT from 2020 to 2023.

### BACKGROUND ART

A technique of collecting and tracking a criminal slang of the related art simply crawls and collects data related to a criminal slang so that it is necessary to develop a technology of analyzing correlation or exposure of the criminal slang.

### DISCLOSURE

### Technical Problem

An object to be achieved by the present disclosure is to provide a criminal slang variation tracking method, an apparatus and a computer program performing the same to acquire criminal slang correlation information for every social network service (SNS) channel.

An object to be achieved by the present disclosure is to provide a criminal slang variation tracking method, an apparatus and a computer program performing the same to acquire criminal slang exposure information to all the plurality of social network service (SNS) channels.

Other and further objects of the present disclosure which are not specifically described can be further considered within the scope easily deduced from the following detailed description and the effect.

### Technical Solution

In order to achieve the above-described technical objects, according to an aspect of the present disclosure, a criminal slang variation tracking method includes: collecting posted contents from each of a plurality of social network service (SNS) channels based on a predetermined criminal slang; acquiring performer activity information corresponding to each posted content by sequentially extracting a nominal word from text data, based on the text data corresponding to the posted content and acquiring the performer activity information including a plurality of nominal words in which the extracted order is stored, based on the posted contents; and acquiring criminal slang correlation information corresponding to the criminal slang for every social network service (SNS) channel, by acquiring an average number of words corresponding to the social network service (SNS) channel, acquiring a co-occurrence value between words according to the performer activity information with the average number of words as a window size, and criminal slang correlation information with the nominal word as a node and the correlation between nominal words as an edge based on the co-occurrence value between words according to the performer activity information, based on the performer activity information corresponding to the posted content for the social network service (SNS) channel.

Here, the acquiring of performer activity information is configured by acquiring the text data corresponding to the posted content based on the posted content, using data preprocess information including data processing content for every social network service (SNS) channel.

Here, the acquiring of performer activity information is configured by acquiring first data including a text from a post of the posted content and identification information of the post, acquiring second text data including a text extracted from a comment of the posted content and identification information of the comment, and acquiring the text data including the first text data and the second text data which is sub level data of the first text data.

Here, the acquiring of performer activity information is configured by extracting a text from an image when the post of the posted content includes the image and acquiring the first text data including a text extracted from a sentence of the post, a text extracted from the image, and identification information of the post.

Here, the acquiring of performer activity information is configured by sequentially extracting a nominal word from the first text data, acquiring first performer activity information including a plurality of nominal words which is extracted from the first text data and has a stored order and identification information of the post, sequentially extracting a nominal word from the second text data, acquiring second performer activity information including a plurality of nominal words which is extracted from the second text data and has a stored order and identification information of the comment, and acquiring the performer activity information including the first performer activity information and the second performer activity information which is sub level data of the first performer activity information.

Here, the acquiring of criminal slang correlation information is configured by removing the performer activity information having a number of words smaller than an average number of words, among the performer activity information corresponding to each posted content for the social network service (SNS) channel and acquiring a co-occurrence value between words according to the remaining performer activity information based on the remaining performer activity information.

Here, the criminal slang correlation information acquiring is configured by, with respect to the performer activity information having a smaller number of words than an average number of words, among the performer activity information corresponding to the posted content for the social network service (SNS) channel, performing zero-padding processing to make the number of words the average number of words by inserting “0” between a first word and a last word and acquiring the co-occurrence value between words according the performer activity information based on the zero-padded performer activity information.

Here, the collecting of posted contents is configured by asynchronously collecting the posted contents including the criminal slang from the plurality of social network service (SNS) channels by means of a plurality of collection instances allocated to every social network service (SNS) channel.

Here, the collecting of posted contents is configured by, when the collection of the posted contents by means of the collection instance allocated to one social network service (SNS) channel is completed, scheduling to allocate the collection instance at which the collection of the posted contents is completed to the other social network service (SNS) channel to collect the posted contents from the other social network service (SNS) channel.

Here, the method further includes: acquiring slang exposure information to all the plurality of social network service (SNS) channels based on the performer activity information corresponding to the posted content collected from each of the plurality of social network service (SNS) channels.

In order to achieve the above-described technical objects, according to an aspect of the present disclosure, a criminal slang variation tracking apparatus is an apparatus of acquiring criminal slang correlation information for every social network service (SNS) channel including: a memory which stores one or more programs to acquire the criminal slang correlation information for every social network service (SNS) channel; and one or more processors which perform an operation for acquiring the criminal slang correlation information for every social network service (SNS) channel according to one or more programs stored in the memory. The processor is configured to collect posted contents from each of the plurality of social network service channels based on a predetermined criminal slang, acquire performer activity information corresponding to each posted content by sequentially extracting a nominal word from text data, based on the text data corresponding to the posted content and acquiring the performer activity information including a plurality of nominal words in which the extracted order is stored, based on the posted contents; and acquire criminal slang correlation information corresponding to the criminal slang for every social network service (SNS) channel, by acquiring an average number of words corresponding to the social network service (SNS) channel, acquiring a co-occurrence value between words according to the performer activity information with the average number of words as a window size, and criminal slang correlation information with the nominal word as a node and the correlation between nominal words as an edge based on the co-occurrence value between words according to the performer activity information, based on the performer activity information corresponding to the posted content for the social network service (SNS) channel.

In order to achieve the above-described technical objects, according to another aspect of the present disclosure, a criminal slang variation tracking method includes: collecting posted contents from each of a plurality of social network service (SNS) channels based on a predetermined criminal slang; acquiring performer activity information corresponding to each posted content by sequentially extracting a nominal word from text data, based on the text data corresponding to the posted content and acquiring the performer activity information including a plurality of nominal words in which the extracted order is stored, based on the posted contents; and acquiring criminal slang exposure information corresponding to the criminal slang for all the plurality of social network service (SNS) channels by acquiring a predetermined number of words to be exposed based on the performer activity information corresponding to the posted content collected from each of the plurality of social network service (SNS) channels, acquiring exposure of the word to be exposed by multiplying a term frequency for all document of the word to be exposed and a document frequency including the word to be exposed, and acquiring the criminal slang exposure information having different letter size of the word to be exposed according to the exposure.

Here, the acquiring of criminal slang exposure information is configured by acquiring a word list including a plurality of words based on all the performer activity information collected from the plurality of social network service (SNS) channels, acquiring the term frequency for all documents of one word by calculating the number of occurrence of one word from the entire performer activity information with respect to a word included in the word list, acquiring the document frequency of one word by calculating the number of performer activity information including one word from the performer activity information, and acquiring the word to be exposed using at least one of the term frequency for all documents and the document frequency for each of the words included in the word list.

Here, the acquiring of criminal slang exposure information is configured by acquiring a word having the document frequency which is a predetermined reference value, as the word to be exposed, among words included in the word list.

Here, the method further includes: acquiring criminal slang correlation information for each social network service (SNS) channel based on the performer activity information corresponding to the posted content.

In order to achieve the above-described technical objects, according to another aspect of the present disclosure, a criminal slang variation tracking apparatus is an apparatus of acquiring criminal slang exposure information to all a plurality of social network service (SNS) channels, including: a memory which stores one or more programs to acquire the criminal slang exposure information to all a plurality of social network service (SNS) channels; and one or more processors which perform an operation for acquiring the criminal slang exposure information to all a plurality of social network service (SNS) channels according to one or more programs stored in the memory. The processor is configured to collect posted contents from each of the plurality of social network service (SNS) channels based on a predetermined criminal slang, acquire performer activity information corresponding to each posted content by sequentially extracting a nominal word from text data, based on the text data corresponding to the posted content and acquiring the performer activity information including a plurality of nominal words in which the extracted order is stored, based on the posted contents; and acquire criminal slang exposure information corresponding to the criminal slang for all the plurality of social network service (SNS) channels by acquiring a predetermined number of words to be exposed based on the performer activity information corresponding to the posted content collected from each of the plurality of social network service (SNS) channels, acquiring exposure of the word to be exposed by multiplying a term frequency for all document of the word to be exposed and a document frequency including the word to be exposed, and acquiring the criminal slang exposure information having different letter size of the word to be exposed according to the exposure.

### Advantageous Effects

According to the exemplary embodiment of the present invention, the criminal slang variation tracking method, the apparatus and the computer program performing the same acquire criminal slang correlation information for every social network service (SNS) channel to analyze correlation between the criminal slangs.

According to the exemplary embodiment of the present invention, the criminal slang variation tracking method, the apparatus and the computer program performing the same acquire criminal slang exposure information to all the plurality of social network service (SNS) channels to analyze exposure between the criminal slangs.

The effects of the present invention are not limited to the technical effects mentioned above, and other effects which are not mentioned can be clearly understood by those skilled in the art from the following description

### DESCRIPTION OF DRAWINGS

FIG. 1 is a block diagram for explaining a criminal slang variation tracking apparatus according to an exemplary embodiment of the present invention.

FIG. 2 is a flowchart for explaining a criminal slang variation tracking method according to an exemplary embodiment of the present invention.

FIG. 3 is a view for explaining an example of a posted content collecting step illustrated in FIG. 2.

FIG. 4 is a view for explaining another example of a posted content collecting step illustrated in FIG. 2.

FIG. 5 is a view for explaining a performer activity information acquiring step illustrated in FIG. 2.

FIG. 6 is a view for explaining a performer activity information acquiring operation illustrated in FIG. 5.

FIG. 7 is a view for explaining a text data acquiring operation illustrated in FIG. 6.

FIG. 8 is a view for explaining details of a performer activity information acquiring operation illustrated in FIG. 6.

FIG. 9 is a view for explaining a criminal slang correlation information acquiring step illustrated in FIG. 2.

FIG. 10 is a view for explaining details of a criminal slang correlation information acquiring operation illustrated in FIG. 9.

FIG. 11 is a view for explaining an example of an operation of acquiring a co-occurrence value between nominal words illustrated in FIG. 10.

FIG. 12 is a view for explaining another example of an operation of acquiring a co-occurrence value between nominal words illustrated in FIG. 10.

FIG. 13 is a view for explaining a result of acquiring criminal slang correlation information according to an exemplary embodiment of the present invention.

FIG. 14 is a flowchart for explaining a criminal slang variation tracking method according to another exemplary embodiment of the present invention.

FIG. 15 is a view for explaining a criminal slang exposure information acquiring step illustrated in FIG. 14.

FIG. 16 is a view for explaining a criminal slang exposure information acquiring operation illustrated in FIG. 15.

FIG. 17 is a view for explaining an operation of acquiring a word to be exposed operation illustrated in FIG. 16.

FIG. 18 is a view for explaining a result of acquiring criminal slang exposure information according to another exemplary embodiment of the present invention.

### BEST MODE

Hereinafter, embodiments of the present disclosure will be described in detail with reference to the accompanying drawings. Advantages and characteristics of the present disclosure and a method of achieving the advantages and characteristics will be clear by referring to exemplary embodiments described below in detail together with the accompanying drawings. However, the present disclosure is not limited to exemplary embodiments disclosed herein but will be implemented in various different forms. The exemplary embodiments are provided by way of example only so that a person of ordinary skilled in the art can fully understand the disclosures of the present invention and the scope of the present invention. Therefore, the present invention will be defined only by the scope of the appended claims. Like reference numerals generally denote like elements throughout the specification.

Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined.

In the specification, the terms “first” or “second” are used to distinguish one component from the other component so that the scope should not be limited by these terms. For example, a first component may also be referred to as a second component and likewise, the second component may also be referred to as the first component.

In the present specification, in each step, numerical symbols (for example, a, b, and c) are used for the convenience of description, but do not explain the order of the steps so that unless the context apparently indicates a specific order, the order may be different from the order described in the specification. That is, the steps may be performed in the order as described or simultaneously, or an opposite order.

In this specification, the terms “have”, “may have”, “include”, or “may include” represent the presence of the characteristic (for example, a numerical value, a function, an operation, or a component such as a part”), but do not exclude the presence of additional characteristic.

Hereinafter, an exemplary embodiment of a criminal slang variation tracking method, an apparatus and a computer program performing the same according to the present disclosure will be described in detail with reference to the accompanying drawings.

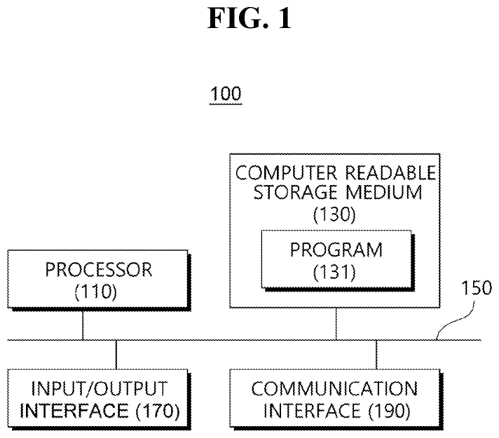

First, a criminal slang variation tracking apparatus according to an exemplary embodiment of the present disclosure will be described with reference to FIG. 1.

FIG. 1 is a block diagram illustrating a criminal slang variation tracking apparatus according to an exemplary embodiment of the present invention.

Referring to FIG. 1, the criminal slang variation tracking apparatus 100 according to an exemplary embodiment of the present disclosure acquires criminal slang correlation information for every social network service (SNS) channel. Further, the criminal slang variation tracking apparatus 100 acquires criminal slang exposure information to all a plurality of social network service (SNS) channels. Accordingly, according to the present disclosure, the correlation between criminal slangs or the exposure of the criminal slang may be analyzed.

To this end, the criminal slang variation tracking apparatus 100 may include one or more processors 110, a computer readable storage medium 130, and a communication bus 150.

The processor 110 controls the criminal slang variation tracking apparatus 100 to operate. For example, the processor 110 may execute one or more programs 131 stored in the computer readable storage medium 130. One or more programs 131 include one or more computer executable instructions and the computer executable instruction which is executed by the processor 110 is configured to allow the criminal slang variation tracking apparatus 100 to perform an operation for acquiring criminal slang correlation information for every social network service (SNS) channel or criminal slang exposure information to all the plurality of social network service (SNS) channels.

The computer readable storage medium 130 is configured to store a computer executable instruction or program code, program data and/or other appropriate type of information to acquire criminal slang correlation information for every social network service (SNS) channel or criminal slang exposure information to all the plurality of social network service (SNS) channels. The program 131 stored in the computer readable storage medium 130 includes a set of instructions executable by the processor 110. In one exemplary embodiment, the computer readable storage medium 130 may be a memory (a volatile memory such as a random access memory, a non-volatile memory, or an appropriate combination thereof), one or more magnetic disk storage devices, optical disk storage devices, flash memory devices, and another format of storage mediums which is accessed by the criminal slang variation tracking apparatus 100 and stores desired information, or an appropriate combination thereof.

The communication bus 150 interconnects various other components of the criminal slang variation tracking apparatus 100 including the processor 110 and the computer readable storage medium 130 to each other.

The criminal slang variation tracking apparatus 100 may include one or more input/output interfaces 170 and one or more communication interfaces 190 which provide an interface for one or more input/output devices. The input/output interface 170 and the communication interface 190 are connected to the communication bus 150. The input/output device (not illustrated) may be connected to the other components of the criminal slang variation tracking apparatus 100 by means of the input/output interface 170.

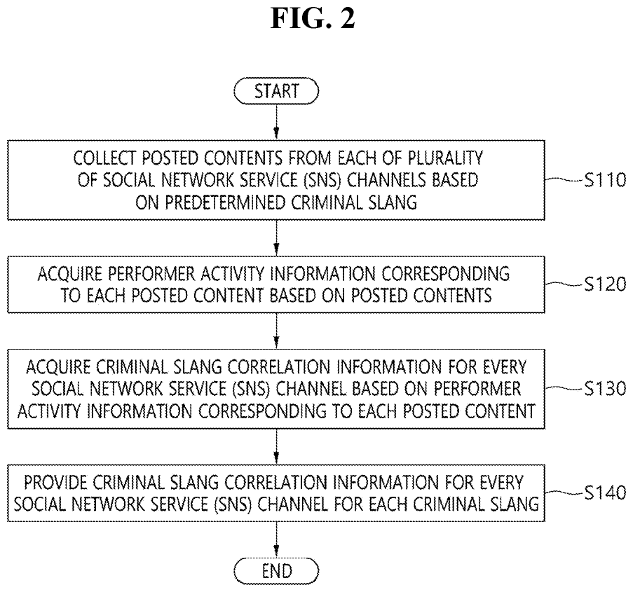

Now, a criminal slang variation tracking method according to an exemplary embodiment of the present disclosure will be described with reference to FIGS. 2 to 13.

### Example of Present Invention: Criminal Slang Variation Tracking Method

FIG. 2 is a flowchart for explaining a criminal slang variation tracking method according to an exemplary embodiment of the present invention.

Referring to FIG. 2, the processor 110 of the criminal slang variation tracking apparatus 100 collects posted contents from a plurality of social network service (SNS) channels based on a predetermined criminal slang in step S110.

That is, the processor 110 collects the posted contents from each of the plurality of social network service (SNS) channels based on the criminal slang, with respect to each criminal slang included in a criminal slang list.

Here, the criminal sling list includes words related to crimes, such as “drug” or “sex crime” or slangs referring to a crime-related word, and has been built in advance to be stored.

The social network service (SNS) channel refers to a channel which provides a social network service (SNS), such as Facebook, Twitter, Instagram, or Tumblr.

The posted contents refer to contents registered in the social network service (SNS) channel by a user who uses the social network service (SNS). The posted contents may be contents including at least one of texts, images, and videos. The posted contents include posts registered by the user and comments which are registered by the other user who reads the posts so as to correspond to the posts.

Next, the processor 110 acquires performer activity information corresponding to the posted contents based on the posted contents in step S120.

Here, the performer activity information is information to confirm a region of interest of the user and includes a plurality of words extracted based on posted contents created by the user.

Next, the processor 110 acquires criminal slang correlation information for every social network service (SNS) channel based on the performer activity information corresponding to the posted channel in step S130.

The criminal slang correlation information may be information obtained by quantifying the correlation between words based on the performer activity information.

Thereafter, the processor 110 provides criminal slang correlation information for every social network service (SNS) channel with respect to each of criminal slangs, in step S140.

That is, the processor 110 provides the criminal slang correlation information of each of criminal slangs for every social network service (SNS) channel, with respect to the criminal slangs included in the criminal slang list, to a user terminal (not illustrated) or a manager terminal (not illustrated).

At this time, the processor 110 provides the criminal slang correlation information for every social network service (SNS) channel, with respect to each of criminal slangs acquired at different timings, to the user terminal or the manager terminal.

### Example of Present Invention: Posted Content Collecting Step

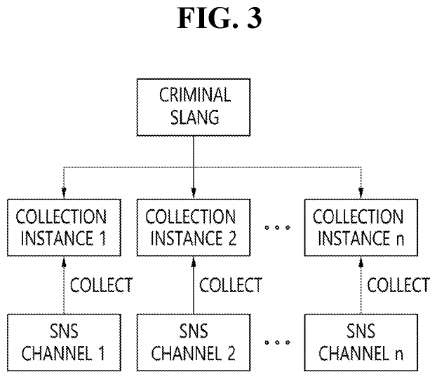

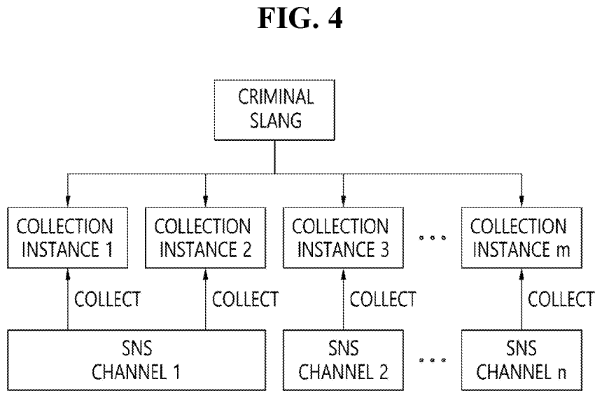

FIG. 3 is a view for explaining an example of a posted content collecting step illustrated in FIG. 2 and FIG. 4 is a view for explaining another example of a posted content collecting step illustrated in FIG. 2.

Referring to FIGS. 3 and 4, the processor 110 collects posted contents from the plurality of social network service (SNS) channels based on the criminal slang.

To be more specific, the processor 110 asynchronously collects the posted contents including the criminal slang from the plurality of social network service (SNS) channels by means of a plurality of collection instances allocated to each social network service (SNS) channel. For example, as illustrated in FIG. 3, the processor 110 generates the same number of collection instances (collection instance 1, collection instance 2, . . . , collection instance n) as the number of social network service (SNS) channels (SNS channel 1, SNS channel 2, . . . , SNS channel n) to allocate one collection instance to every social network service (SNS) channel (SNS channel 1, SNS channel 2, . . . , SNS channel n). By doing this, each of the plurality of collection instances (collection instance 1, collection instance 2, . . . , collection instance n) asynchronously collects the posted contents including a criminal slang which is a search word, from the social network service (SNS) channel allocated thereto.

The processor 110 collects the posted contents by allocating a plurality of collection instances to a specific social network service (SNS) channel, based on an amount of posted contents to be collected for every social network service (SNS) channel. For example, as illustrated in FIG. 4, the processor 110 allocates two collection instances (collection instance 1 and collection instance 2) to the social network service (SNS) channel 1.

When the collection of the posted contents by means of the collection instance allocated to one social network service (SNS) channel is completed, the processor 110 is scheduled to allocate the collection instance at which the collection of the posted contents is completed to the other social network service (SNS) channel to collect the posted contents from the other social network service (SNS) channel.

In the meantime, the processor 110 collects posted contents by means of a server (not illustrated) specified by a service provider who operates the social network service (SNS) or collects the posted contents by means of a server specified by a company which mirrors and provides social network service (SNS) data.

As described above, according to the present invention, posted contents are asynchronously collected from the plurality of social network service (SNS) channels by means of the plurality of collection instances, to increase a data collection efficiency and minimize the system resource consumption.

### Example of Present Invention: Performer Activity Information Acquiring Step

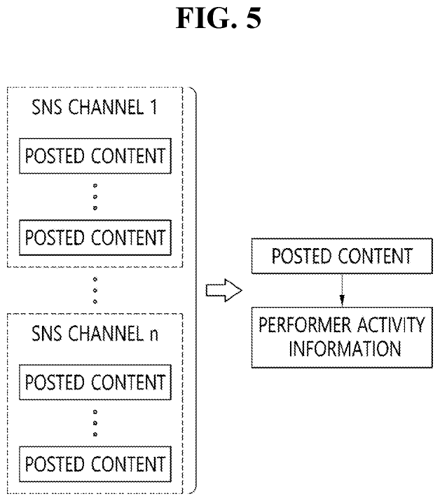

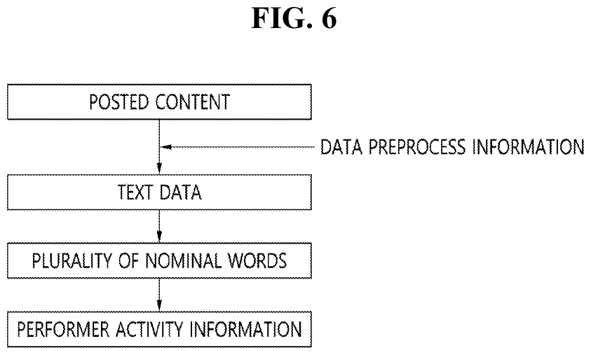

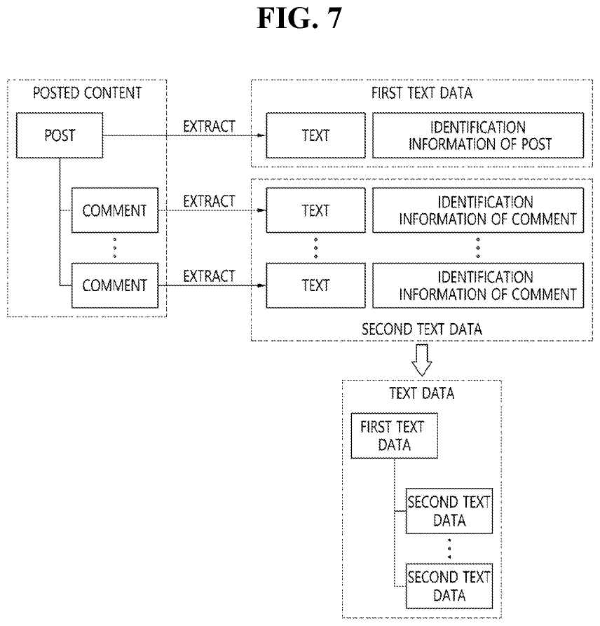

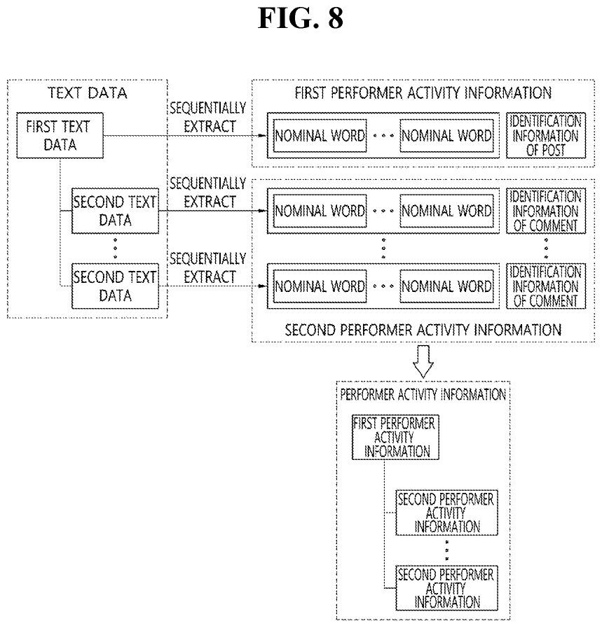

FIG. 5 is a view for explaining a performer activity information acquiring step illustrated in FIG. 2, FIG. 6 is a view for explaining a performer activity information acquiring operation illustrated in FIG. 5, FIG. 7 is a view for explaining a text data acquiring operation illustrated in FIG. 6, and FIG. 8 is a view for explaining details of a performer activity information acquiring operation illustrated in FIG. 6.

Referring to FIGS. 5 to 8, the processor 110 acquires performer activity information corresponding to the posted contents based on the posted contents. For example, as illustrated in FIG. 5, the processor 110 acquires performer activity information based on the posted contents, with respect to each posted content collected from each of the plurality of social network service (SNS) channels (SNS channel 1, . . . , SNS channel n).

To be more specific, the processor 110 may sequentially extract nominal words from text data based on text data corresponding to the posted contents. Here, the processor 110 extracts a nominal word from text data using a nominal word extraction algorithm which has been known in the related art, such as open Korean text (OKT) class of KoNLP.

At this time, as illustrated in FIG. 6, the processor 110 acquires text data corresponding to the posted contents based on the posted contents, using data preprocess information including data processing contents for every social network service (SNS) channel.

Here, the data preprocess information refers to information in which whether to extract text according to a content type (text, image, or video) included in the posted content is specified for every social network service (SNS) channel. For example, when the posted contents of the specific social network service (SNS) channel include all the text, the image, and the video, the data preprocess information is set to extract the text from the text and the image included in the posted contents collected from the social network service (SNS) channel and set not to extract the text from the video included in the posted contents. In this case, the processor 110 may not extract a text from the video included in the posted contents collected from the social network service (SNS) channel based on the data preprocess information.

That is, as illustrated in FIG. 7, the processor 110 acquires first text data including a text extracted from the post of the posted contents and identification information of the post (including information to identify the SNS channel, information to identify a user who registers the post, such as ID, a time when the post is registered, and information to identify the post itself). At this time, when the image is included in the post of the posted contents, the processor 110 extracts a text from the image and acquires first text data including a text extracted from a sentence of the post, a text extracted from an image, and identification information of the post. Here, the processor 110 extracts the text from the image using a text extraction algorithm which has been known in the related art, such as OCR API. Further, the processor 110 acquires second text data including a text extracted from a comment of the posted contents and identification information of the comment (including information to identify the post corresponding to the comment, information to identify a user who registers the comment, such as ID, a time when the comment is registered, and information to identify the comment itself). Further, the processor 110 acquires text data including first text data and second text data which is sub level data of the first text data.

The processor 110 acquires performer activity information including a plurality of nominal words whose extracted order is stored.

That is, as illustrated in FIG. 8, the processor 110 sequentially extracts nominal words from the first text data and acquires first performer activity information including a plurality of nominal words which is extracted from the first text data and has a stored order and identification information of the post. Further, the processor 110 sequentially extracts nominal words from the second text data and acquires second performer activity information including a plurality of nominal words which is extracted from the second text data and has a stored order and identification information of the comment. Further, the processor 110 acquires performer activity information including first performer activity information and second performer activity information which is sub level data of the first performer activity information.

### Example of Present Invention: Criminal Slang Correlation Information Acquiring Step

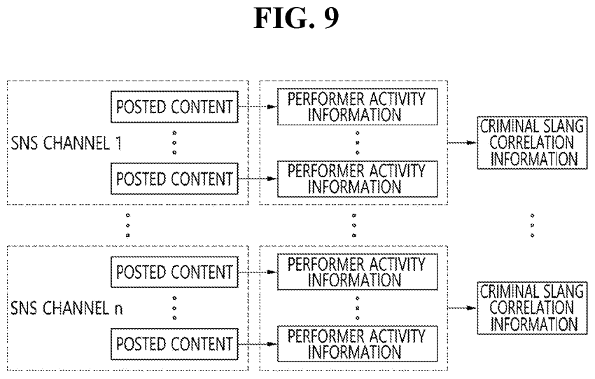

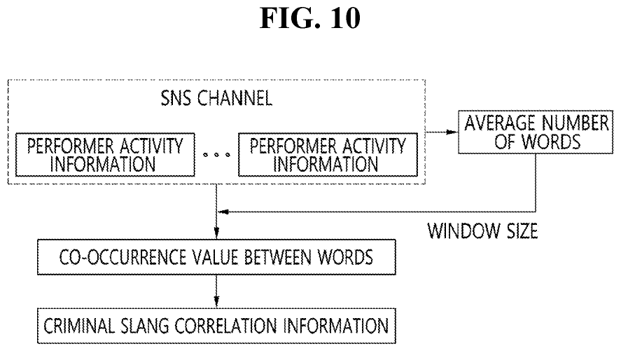

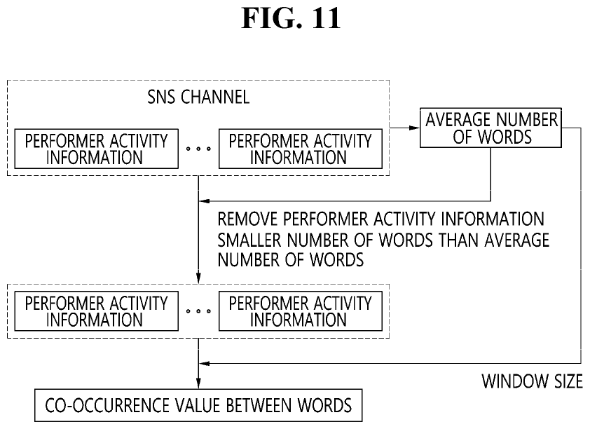

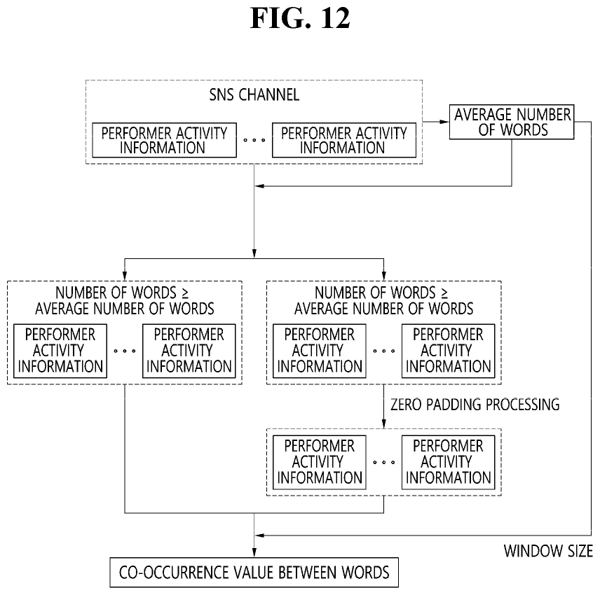

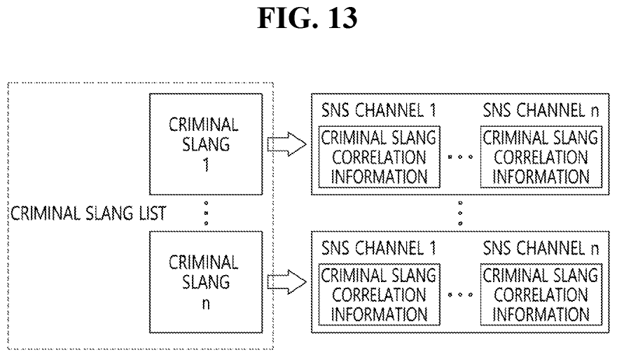

FIG. 9 is a view for explaining a criminal slang correlation information acquiring step illustrated in FIG. 2, FIG. 10 is a view for explaining details of a criminal slang correlation information acquiring operation illustrated in FIG. 9, FIG. 11 is a view for explaining an example of an operation of acquiring a co-occurrence value between words illustrated in FIG. 10, FIG. 12 is a view for explaining another example of an operation of acquiring a co-occurrence value between words illustrated in FIG. 10, and FIG. 13 is a view for explaining a result of acquiring criminal slang correlation information according to an exemplary embodiment of the present invention.

Referring to FIGS. 9 to 13, the processor 110 acquires criminal slang correlation information for every social network service (SNS) channel based on the performer activity information corresponding to each posted channel. For example, as illustrated in FIG. 9, the processor 110 acquires criminal slang correlation information for a social network service (SNS) channel 1 based on performer activity information for each of posted contents collected from the social network service (SNS) channel 1 and acquires criminal slang correlation information for a social network service (SNS) channel n based on performer activity information for each of posted contents collected from the social network service (SNS) channel n.

At this time, the processor 110 acquires criminal slang correlation information based on only the first performer activity information of the performer activity information corresponding posted contents, from the performer activity information including first performer activity information corresponding to the post of the posted content and second performer activity information corresponding to the comment of the posted content.

To be more specific, as illustrated in FIG. 10, the processor 110 acquires an average number of words corresponding to the social network service (SNS) channel, based on the performer activity information corresponding to each posted content for the social network service (SNS) channel.

As illustrated in FIG. 10, the processor 110 acquires a co-occurrence value between nominal words according to the performer activity information with the average number of words as a window size. Here, the processor 110 acquires co-occurrence value between nominal words using a word correlation analysis algorithm which has been known in the related art, such as TextRank API.

At this time, as illustrated in FIG. 11, the processor 110 removes the performer activity information having a smaller number of words than an average number of words, among the performer activity information corresponding to the posted content for the social network service (SNS) channel and acquires the co-occurrence value between nominal words according the remaining performer activity information based on the remaining performer activity information.

As illustrated in FIG. 12, with respect to the performer activity information having a smaller number of words than an average number of words, among the performer activity information corresponding to the posted content for the social network service (SNS) channel, the processor 110 inserts “0” between a first word and a last word to perform zero-padding to make the number of words the average number of words and acquires the co-occurrence value between nominal words according the performer activity information based on the zero-padded performer activity information. For example, when the average number of words is 4 and the number of words of the performer activity information “word 1 and word 2” corresponding to a specific posted content is two, the processor 110 performs the zero-padding to insert 0 into the performer activity information to correct the performer activity information “word 1 and word 2” to “words 1, 0, 0, word 2”.

As illustrated in FIG. 10, the processor 110 acquires the criminal slang correlation information based on the co-occurrence value between nominal words according to the performer activity information.

That is, the processor 110 acquires criminal slang correlation information with each nominal word as a node and correlation between nominal words as edge, based on the co-occurrence value between nominal words according to the performer activity information. Here, the processor 110 acquires the criminal slang correlation information using a visualization algorithm which has been known in the related art, such as GraphAware API.

At this time, the processor 110 varies a size of the node corresponding to the nominal word based on the correlation value with respect to the nominal word and varies a size of the edge based on the co-occurrence value between words. For example, the processor 110 increases the size of the node and increases the thickness of the edge as the correlation value increases.

In summary, according to the present invention, the criminal slang correlation information acquiring process described above is performed on each criminal slang included in the criminal slang list to acquire criminal slang correlation information for every social network service (SNS) channel (SNS channel 1, . . . , SNS channel n) with respect to each criminal slang (criminal slang 1, . . . , criminal slang n), as illustrated in FIG. 13.

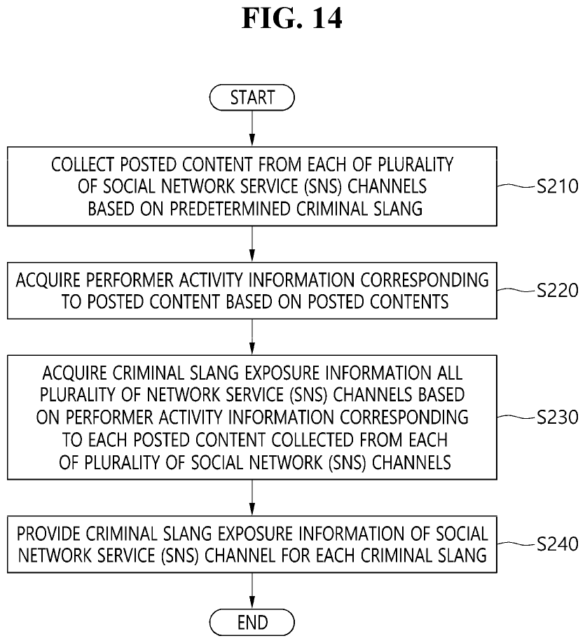

Now, a criminal slang variation tracking method according to another exemplary embodiment of the present disclosure will be described with reference to FIGS. 14 to 18.

### Another Example of Present Invention Criminal Slang Variation Tracking Method

FIG. 14 is a flowchart for explaining a criminal slang variation tracking method according to another exemplary embodiment of the present invention.

Referring to FIG. 14, the processor 110 of the criminal slang variation tracking apparatus 100 collects posted contents from a plurality of social network service (SNS) channels based on a predetermined criminal slang in step S210.

The posted content collecting step S210 according to the present exemplary embodiment is the same as the posted content collecting step S110 according to the above-described exemplary embodiment, so that a detailed description will be omitted.

Next, the processor 110 acquires performer activity information corresponding to each posted contents based on the posted contents in step S220.

The performer activity information acquiring step S220 according to the exemplary embodiment is the same as the performer activity information acquiring step S120 according to the above-described exemplary embodiment so that a detailed description will be omitted.

Next, the processor 110 acquires criminal slang exposure information to all the plurality of social network service (SNS) channels based on the performer activity information corresponding to each posted content collected from each of the plurality of social network service (SNS) channels in step S230.

Here, the criminal slang exposure information may be information obtained by quantifying an exposure frequency of a word (word occurrence frequency) based on the performer activity information.

Thereafter, the processor 110 provides criminal slang exposure information to the social network service (SNS) channel for each of criminal slangs in step S240.

That is, the processor 110 provides criminal slang exposure information to all the social network service (SNS) channels of the criminal slang, with respect to the criminal slang included in the criminal slang list, to the user terminal or the manager terminal.

At this time, the processor 110 provides the criminal slang exposure information to all the social network service (SNS) channels of the criminal slangs acquired at different timings, to the user terminal or the manager terminal.

### Another Example of Present Invention Criminal Slang Exposure Information Acquiring Step

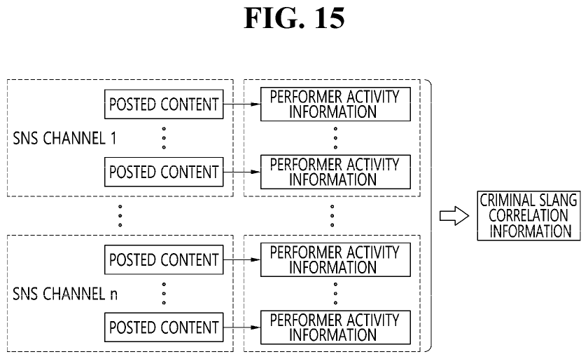

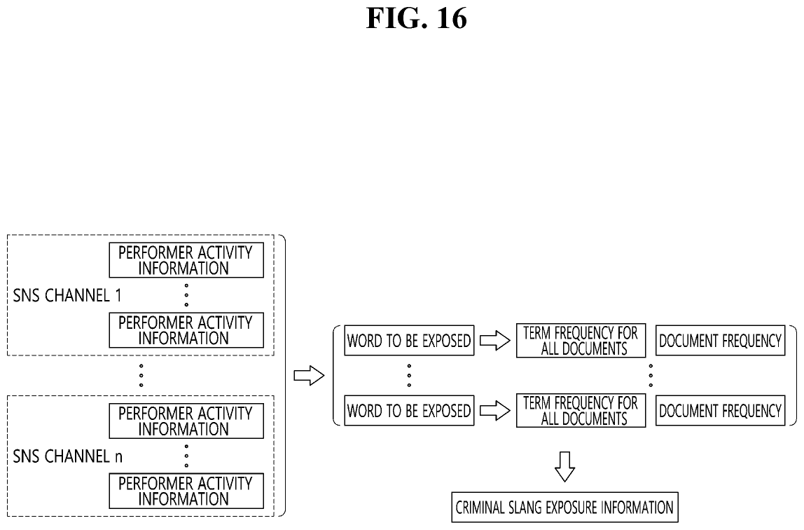

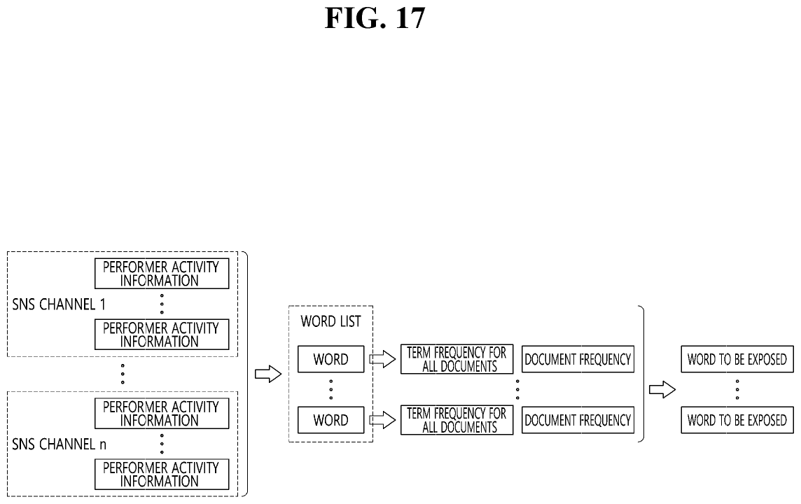

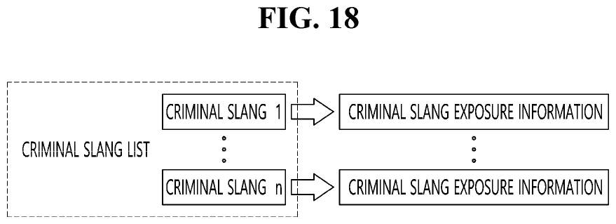

FIG. 15 is a view for explaining a criminal slang exposure information acquiring step illustrated in FIG. 14, FIG. 16 is a view for explaining a criminal slang exposure information acquiring operation illustrated in FIG. 15, FIG. 17 is a view for explaining an operation of acquiring a word to be exposed illustrated in FIG. 16, and FIG. 18 is a view for explaining a result of acquiring criminal slang exposure information according to another exemplary embodiment of the present invention.

Referring to FIGS. 15 to 18, the processor 110 acquires criminal slang exposure information to all the plurality of social network service (SNS) channels based on the performer activity information corresponding to each posted content collected from each of the plurality of social network service (SNS) channels. For example, as illustrated in FIG. 15, the processor 110 acquires the criminal slang exposure information to all the plurality of social network service (SNS) channels (SNS channel 1, . . . , SNS channel n) based on the performer activity information collected from each of the plurality of social network service (SNS) channels (SNS channel 1, . . . , SNS channel n).

At this time, the processor 110 acquires criminal slang exposure information based on only the first performer activity information of the performer activity information corresponding posted contents, from the performer activity information including first performer activity information corresponding to the post of the posted contents and second performer activity information corresponding to the comment of the posted contents.

The processor 110 acquires the criminal slang exposure information with first performer activity information and second performer activity information as performer activity information having the same position. Here, the processor 110 selects only the second performer activity information having a number of words larger than a predetermined reference value (for example, 4), among second performer activity information, as performer activity information having the same position as the first performer activity information.

To be more specific, as illustrated in FIG. 16, the processor 110 acquires a predetermined number of words to be exposed, based on the performer activity information corresponding to each posted content.

That is, as illustrated in FIG. 17, the processor 110 acquires a word list including a plurality of words based on all performer activity information collected from the plurality of social network service (SNS) channels (SNS channel 1, . . . , SNS channel n).

The processor 110 acquires a term frequency for all documents by calculating an occurrence frequency of one word from all the performer activity information, with respect to each word included in the word list. The processor 110 acquires a document frequency of one word by calculating the number of performer activity information including one word, from all the performer activity information. The processor 110 acquires a word to be exposed using at least one of the term frequency for all documents and the document frequency with respect to each word included in the word list. For example, the processor 110 acquires a word having a document frequency which is equal to or larger than a predetermined reference value (for example, “15”), among words included in the word list, as a word to be exposed. When the number of words having the document frequency which is equal to or larger than a predetermined reference value is larger than the number of words to be exposed, the processor 110 selects a word to be exposed in the order of larger value, using at least one of term frequency for all documents and the document frequency.

For example, the processor 110 acquires a word having the document frequency which is equal to or larger than a predetermined reference value (for example, “15”) and acquires a predetermined number of words to be exposed in the order of larger values obtained by multiplying the term frequency for all documents “TF_A” and the inverse document frequency IDF, based on the term frequency for all documents TF_A, the document frequency DF, and the inverse document frequency IDF calculated by the following Equation 1.

$$IDF ( d , t ) = log ( \frac{n}{1 + df ( t )} ) \qquad [ Equation 1 ]$$

Here, IDF(d,t) indicates the inverse document frequency of a word t in the entire word (that is, the entire performer activity information) and is inversely proportional to the document frequency df(t). df(t) indicates a number of documents (that is, the performer activity information) in which the word t appears. n denotes a number of documents (that is, the performer activity information).

As illustrated in FIG. 16, the processor acquires criminal slang exposure information based on the term frequency for all documents of the word to be exposed and the document frequency including the word to be exposed.

For example, the processor 110 acquires the exposure of the word to be exposed by multiplying the term frequency for all documents and the document frequency of the word to be exposed and acquires the criminal slang exposure information having a letter size of the word to be exposed which varies according to the exposure. That is, the processor 110 may increase the letter size as the value of the exposure is increased. The processor 110 may also acquire the exposure of the word to be exposed by multiplying the term frequency for all documents and the inverse document frequency of the word to be exposed.

In summary, according to the present invention, the criminal slang exposure information acquiring process described above is performed on each criminal slang included in the criminal slang list to acquire criminal slang exposure information to all the plurality of every social network service (SNS) channels with respect to each criminal slang (criminal slang 1, . . . , criminal slang n), as illustrated in FIG. 18.

### Still Example of Present Invention Criminal Slang Variation Tracking Method

According to another exemplary embodiment of the present disclosure, both an operation of acquiring criminal slang correlation information for every social network service (SNS) channel which is the criminal slang variation tracking method according to the exemplary embodiment of the present information and an operation of acquiring criminal slang exposure information to all the plurality of social network service (SNS) channels which is the criminal slang variation tracking method according to another exemplary embodiment of the present information are performed.

The operation according to the exemplary embodiment of the present disclosure may be implemented as a program instruction which may be executed by various computers to be recorded in a computer readable storage medium. The computer readable storage medium indicates an arbitrary medium which participates to provide a command to a processor for execution. The computer readable storage medium may include solely a program command, a data file, and a data structure or a combination thereof. For example, the computer readable medium may include a magnetic medium, an optical recording medium, and a memory. The computer program may be distributed on a networked computer system so that the computer readable code may be stored and executed in a distributed manner. Functional programs, codes, and code segments for implementing the present embodiment may be easily inferred by programmers in the art to which this embodiment belongs.

The present embodiments are provided to explain the technical spirit of the present embodiment and the scope of the technical spirit of the present embodiment is not limited by these embodiments. The protection scope of the present embodiments should be interpreted based on the following appended claims and it should be appreciated that all technical spirits included within a range equivalent thereto are included in the protection scope of the present embodiments.

1. A criminal slang variation tracking method comprising:
collecting posted contents from each of a plurality of social network service (SNS) channels based on a predetermined criminal slang;
acquiring performer activity information corresponding to each posted content by sequentially extracting a nominal word from text data, based on the text data corresponding to the posted content and acquiring the performer activity information including a plurality of nominal words in which the extracted order is stored, based on the posted contents; and
acquiring criminal slang correlation information corresponding to the criminal slang for every social network service (SNS) channel, by acquiring an average number of words corresponding to the social network service (SNS) channel, acquiring a co-occurrence value between words according to the performer activity information with the average number of words as a window size, and criminal slang correlation information with the nominal word as a node and the correlation between nominal words as an edge based on the co-occurrence value between words according to the performer activity information, based on the performer activity information corresponding to the posted content for the social network service (SNS) channel.

2. The criminal slang variation tracking method of claim 1, wherein the acquiring of performer activity information is configured by acquiring the text data corresponding to the posted content based on the posted content, using data preprocess information including data processing content for every social network service (SNS) channel.

3. The criminal slang variation tracking method of claim 2, wherein the acquiring of performer activity information is configured by acquiring first data including a text from a post of the posted content and identification information of the post, acquiring second text data including a text extracted from a comment of the posted content and identification information of the comment, and acquiring the text data including the first text data and the second text data which is sub level data of the first text data.

4. The criminal slang variation tracking method of claim 3, wherein the acquiring of performer activity information is configured by extracting a text from an image and acquiring the first text data including a text extracted from a sentence of the post, a text extracted from the image, and identification information of the post when the post of the posted content includes the image.

5. The criminal slang variation tracking method of claim 3, wherein the acquiring of performer activity information is configured by sequentially extracting a nominal word from the first text data, acquiring first performer activity information including a plurality of nominal words which is extracted from the first text data and has a stored order and identification information of the post, sequentially extracting a nominal word from the second text data, acquiring second performer activity information including a plurality of nominal words which is extracted from the second text data and has a stored order and identification information of the comment, and acquiring the performer activity information including the first performer activity information and the second performer activity information which is sub level data of the first performer activity information.

6. The criminal slang variation tracking method of claim 1, wherein the acquiring of criminal slang correlation information is configured by removing the performer activity information having a number of words smaller than an average number of words, among the performer activity information corresponding to each posted content for the social network service (SNS) channel and acquiring a co-occurrence value between nominal words according to the remaining performer activity information based on the remaining performer activity information.

7. The criminal slang variation tracking method of claim 1, wherein the criminal slang correlation information acquiring is configured by performing zero-padding processing on the performer activity information having a smaller number of words than an average number of words, among the performer activity information corresponding to the posted content for the social network service (SNS) channel to make the number of words the average number of words by inserting “0” between a first word and a last word and acquiring the co-occurrence value between nominal words according the performer activity information based on the zero-padded performer activity information.

8. The criminal slang variation tracking method of claim 1, wherein the collecting of posted contents is configured by asynchronously collecting the posted contents including the criminal slang from the plurality of social network service (SNS) channels by means of a plurality of collection instances allocated to every social network service (SNS) channel.

9. The criminal slang variation tracking method of claim 8, wherein the collecting of posted contents is configured by, when the collection of the posted contents by means of the collection instance allocated to one social network service (SNS) channel is completed, scheduling to allocate the collection instance at which the collection of the posted contents is completed to the other social network service (SNS) channel to collect the posted contents from the other social network service (SNS) channel.

10. The criminal slang variation tracking method of claim 1, further comprising:
acquiring slang exposure information to all the plurality of social network service (SNS) channels based on the performer activity information corresponding to the posted content collected from each of the plurality of social network service (SNS) channels.

11. An apparatus of acquiring criminal slang correlation information for every social network service (SNS) channel, comprising:
a memory which stores one or more programs to acquire the criminal slang correlation information for every social network service (SNS) channel; and
one or more processors which perform an operation for acquiring the criminal slang correlation information for every social network service (SNS) channel according to one or more programs stored in the memory,
wherein the processor is configured to collect posted contents from each of the plurality of social network service channels based on a predetermined criminal slang, acquire performer activity information corresponding to each posted content by sequentially extracting a nominal word from text data, based on the text data corresponding to the posted content and acquiring the performer activity information including a plurality of nominal words in which the extracted order is stored, based on the posted contents; and acquire criminal slang correlation information corresponding to the criminal slang for every social network service (SNS) channel, by acquiring an average number of words corresponding to the social network service (SNS) channel, acquiring a co-occurrence value between nominal words according to the performer activity information with the average number of words as a window size, and criminal slang correlation information with the nominal word as a node and the correlation between nominal words as an edge based on the co-occurrence value between nominal words according to the performer activity information, based on the performer activity information corresponding to the posted content for the social network service (SNS) channel.

12. A criminal slang variation tracking method comprising:
collecting posted contents from each of a plurality of social network service (SNS) channels based on a predetermined criminal slang;
acquiring performer activity information corresponding to each posted content by sequentially extracting a nominal word from text data, based on the text data corresponding to the posted content and acquiring the performer activity information including a plurality of nominal words in which the extracted order is stored, based on the posted contents; and
acquiring criminal slang exposure information corresponding to the criminal slang for all the plurality of social network service (SNS) channels by acquiring a predetermined number of words to be exposed based on the performer activity information corresponding to the posted content collected from each of the plurality of social network service (SNS) channels, acquiring exposure of the word to be exposed by multiplying a term frequency for all document of the word to be exposed and a document frequency including the word to be exposed, and acquiring the criminal slang exposure information having different letter size of the word to be exposed according to the exposure.

13. The criminal slang variation tracking method of claim 12, wherein the acquiring of criminal slang exposure information is configured by acquiring a word list including a plurality of words based on all the performer activity information collected from the plurality of social network service (SNS) channels, acquiring the term frequency for all documents of one word by calculating a term frequency for all documents of one word from the entire performer activity information with respect to a word included in the word list, acquiring the document frequency of one word by calculating the number of performer activity information including one word from the performer activity information, and acquiring the word to be exposed using at least one of the term frequency for all documents and the document frequency for each of the words included in the word list.

14. The criminal slang variation tracking method of claim 13, wherein the acquiring of criminal slang exposure information is configured by acquiring a word having the document frequency which is a predetermined reference value, as the word to be exposed, among words included in the word list.

15. The criminal slang variation tracking method of claim 12, further comprising:
acquiring criminal slang correlation information for each social network service (SNS) channel based on the performer activity information corresponding to the posted content.

16. An apparatus of acquiring criminal slang exposure information to all a plurality of social network service (SNS) channels, comprising:
a memory which stores one or more programs to acquire the criminal slang exposure information to all a plurality of social network service (SNS) channels; and
one or more processors which perform an operation for acquiring the criminal slang exposure information to all a plurality of social network service (SNS) channels according to one or more programs stored in the memory,
wherein the processor is configured to collect posted contents from each of the plurality of social network service (SNS) channels based on a predetermined criminal slang, acquire performer activity information corresponding to each posted content by sequentially extracting a nominal word from text data, based on the text data corresponding to the posted content and acquiring the performer activity information including a plurality of nominal words in which the extracted order is stored, based on the posted contents; and acquire criminal slang exposure information corresponding to the criminal slang for all the plurality of social network service (SNS) channels by acquiring a predetermined number of words to be exposed based on the performer activity information corresponding to the posted content collected from each of the plurality of social network service (SNS) channels, acquiring exposure of the word to be exposed by multiplying a term frequency for all document of the word to be exposed and a document frequency including the word to be exposed, and acquiring the criminal slang exposure information having different letter size of the word to be exposed according to the exposure.
